(19) United States
(12) Patent Application Publication
(10) Pub. No.: US 2015/0156201 A1
(43) Pub. Date: Jun. 4, 2015

(54) METHOD FOR SHARING A MEDIA COLLECTION IN A NETWORK ENVIRONMENT

(71) Applicant: Yahoo! Inc., Sunnyvale, CA (US)

(72) Inventors: Matthew David New, Irvine, CA (US); Jonathan Cooper Ochenas, Santa Monica, CA (US); Carl Joseph Sobeski, West Pittson, PA (US)

(73) Assignee: Yahoo! Inc., Sunnyvale, CA (US)

(21) Appl. No.: 14/093,406

(22) Filed: Nov. 29, 2013

(51) Int. Cl. H04L 29/06; G06F 21/10

(52) U.S. Cl. CPC H04L 63/10; G06F 21/105

(57) ABSTRACT

A method of acquiring rights to content to be burned to a CD, comprising defining a first content set; defining a second content set comprised of content selected from the first content set whose content attributes match those selected by a user; identifying as a third content set that content in the second content set for which DRM rights sufficient to permit the content to be burned to CD are not currently possessed; allowing a user to authorize obtaining rights for members of the second content set for which rights permitting the content to be burned to CD are not currently possessed; obtaining rights which allow at least a subset of the third content set to be burned to CD; and, allowing the content defined in the second content set and for which appropriate rights have been obtained to be burned to CD.

This application is a continuation of U.S. patent application Ser. No. 11/303,096, entitled “System and Method For Improved Portable Media File Retention”, which claims priority from Provisional U.S. Patent Application Ser. No. 60/657,222, filed Feb. 28, 2005, and Provisional U.S. Patent No. 60/678,718 filed May 5, 2005, which are hereby incorporated by reference in their entirety. This application is also related to the U.S. patent application Ser. No. 11/303,097, entitled “Portable Media Delivery Interoperability”, filed on Dec. 16, 2005, the contents of which are hereby incorporated by reference in their entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of media CDs, and more specifically to the creation and maintenance of playlists for CD-ROM and other removable CDs.

### BACKGROUND OF THE INVENTION

The advent of digital computers has greatly changed how users transport and access music, movies, television shows, photographs, and other sensory-stimulating content. Digital recording, storage, and reproduction technologies allow users to experience a wide variety of content from relatively small, portable CDs such as CDROM and DVD players. As used herein, the term “CD player” is intended to include, but is not limited to, CDs capable of playing and/or recording CD-ROM's, DVDs, and other portable, removable media. Similarly, the terms “CD” and “CD-ROM” are intended to include, but are not limited to, write-once and rewritable portable, removable media, including, without limitation, CD+RW, DVD-RW, BluRay DVDs, and the like.

The creation of the Motion Picture Entertainment Group Layer 3 (“MP3”) audio encoding standard has allowed CD's to carry even more than the 72 or 80 minutes of music traditionally carried by such media by changing the method by in which the audio files are stored. Similarly, inexpensive, high-resolution digital video cameras are now available for home and professional video creation, and a wide variety of software is available that allows consumers and professionals to easily create new content. Combined with the popularity and low cost of CD writing hardware (referred to generally as “burners”) and the related media, this has lead to an explosion in the number of portable CD players.

While portable CD players give users the ability to carry entire music and/or video libraries or other such single- and multi-media content on a handful of physical media, such CDs often pose unique problems for users. For example, users can become bored with accessing the same content over and over, even where the order and/or frequency of playback is determined through one or more playlists. Thus, users frequently wish to update their CD's with new content.

Users can add content to a CD, and especially a rewritable CD, through a variety of means. With respect to music content, such means include creating one or more content files from songs on a commercial audio CD, DVD, audio or video tape, or phonograph, a process referred to as “ripping”. While ripping is popular, it requires that a user visit a bricks-and-mortar or online retailer, purchase the CD or other physical copy of the content, and then take the time to convert the content file or files into the desired format and burn the ripped content to a new CD. This is both time consuming and technologically challenging for many consumers. To help facilitate users gaining access to larger music libraries, and thus allowing users to enhance the scope of content available on CD's, some services have been launched through which a user can download an MP3 or other content file from an online music source.

Several different content sources have become available in recent years, and many use differing business models. One business model, supported by the Yahoo! Music Engine service offered by Yahoo!, Inc. of Sunnyvale, Calif., is the “tethered-download” or subscription model. In this model, users pay a flat fee to download content files from a central source to their home computer. This flat fee is typically relatively low because content downloaded from such services is protected using digital rights management (“DRM”) technology, and will frequently expire (i.e. cannot be played or accessed) if the user stops subscribing to the service.

While such services have gained in popularity, not all content can be burned to CD's, because CD players do not generally support digital rights management. Thus, the user is not able to take full advantage of the content provided by such services.

### SUMMARY OF THE INVENTION

Accordingly, the present invention is directed to a system and method creating playlists for CD's, and for obtaining appropriate DRM rights for the content in such playlists, that substantially obviates one or more of the problems due to limitations and disadvantages of the related art.

It is an object of the present invention to provide a method of acquiring rights to content to be burned to a CD, comprising defining a first content set, wherein at least one content attribute is associated with each member of the first content set; defining a second content set, wherein the second content set is comprised of content selected from the first content set whose content attributes match those selected by a user; identifying as a third content set that content in the second content set for which digital rights management rights sufficient to permit the content to be burned to the CD are not currently possessed; allowing a user to authorize obtaining rights for at least a subset of the second content set for which rights sufficient to permit the content to be burned to the CD are not currently possessed; obtaining rights which allow at least a subset of the third content set to be burned to the CD; and, allowing the content defined in the second content set and for which appropriate rights have been obtained to be burned to the CD.

It is a further object of the invention to provide A user interface for defining content to be burned to a CD, comprising a list of available content; a selected content list; and a transfer content user interface element; wherein the user interface allows content from the list of available content to be added to the selected content list, wherein content in the selected content list for which the user has appropriate rights to allow the content to be burned to a CD are presented differently than other content, and wherein, upon activation of the transfer content user interface element, rights are obtained to burn to the CD any content in the selected content list for which the user does not have appropriate rights.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

An embodiment of the invention is implemented as part of content management software for CD's. The software allows a user to easily build one or more “playlists”, or lists of content to be burned to a CD, and to associate the playlist with a given CD such that changes to the content in the playlist are automatically transferred to the CD when the CD is synchronized or otherwise connected to a content source, or such a content source is made available to the CD. Such content sources may include, without limitation, content stored on a computer associated with the user, content stored remotely on a server, and content available from other users.

In a preferred embodiment, playlists may include individual content entries selected by the user (such as by dragging and dropping entries from a list of available content onto the playlist), and/or rules by which content available to the user can be selected for inclusion in the playlist. By way of example, without intending to limit the present invention, a playlist rule may indicate that all content by the user's three favorite artists are to be given the highest priority, and that randomly selected content of a specific genre is to be given the next highest priority. The software can then select from the available content that content which meets the user-defined rules and can add such content to the playlist.

The software can also preferably monitor content added to a playlist and automatically determine whether the user has the rights necessary to allow the content to be burned to the CD. By way of example, without intending to limit the present invention, the user may specify that as new content from a favorite artist becomes available, that content should be automatically added to the playlist, and sufficient DRM rights to the content should be obtained which allow the content to be burned to the CD.

In one embodiment, the software also provides visual feedback to the user regarding the DRM licensing status of particular content with respect to a given CD. Such feedback may include, but is not limited to, displaying the title, artist, track, or other information associated with content for which the user does not have an appropriate DRM license in a different font, altering the color of the font, altering the background behind the text, striking through the text, drawing a box around the text, or the like. Furthermore, the software may order the playlist so that entries corresponding to content for which appropriate licensing information is not available appear at the bottom or top of the playlist, or in an alternative window or portion of the window associated with the playlist.

The software can also allow new content to be burned to a CD. Such content can be selected based on the contents of a playlist. By way of example, without intending to limit the present invention, a user's preferences may be determined based on the frequency with which an artist or genre appears within a playlist, based on the frequency with which a particular content file is played by the user, based on the user's ratings of different content within the playlist, or combinations thereof. The software can then select new content that has similar characteristics to those preferred by the user and the new content can be added to the playlist, thereby allowing the user to access new content. Similarly, rules associated with a playlist may be used to select appropriate content.

Where a CD is capable of storing new content, the new content can merely be added to the CD. However, where the CD is too full to allow new content to be copied thereto, the software can substitute the new content for content in the playlist associated with the CD. The user can preferably control the number of playlist entries and/or content files that can be substituted, and the frequency with which such substitutions may occur. The user can also preferably control the manner in which the software chooses a content file or files for which the new content is to be substituted. By way of example, without intending to limit the present invention, the user may choose the content files to be removed, the user may choose to have the lowest rated content removed first, or the user may choose to have the least frequently accessed content removed first.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of at least one embodiment of the invention.

In the drawings:

FIG. 1 is a block diagram illustrating a method through which content can be added to a CD.

FIG. 2 is a block diagram of a network architecture capable of supporting the present invention.

FIG. 3 is a screen capture illustrating a user interface through which individual content files can be added to a play list, and through which a CD can be burned.

FIG. 4 is a screen capture illustrating a user interface through which track licensing status is provided to the user.

FIG. 5 is a screen capture illustrating a user interface through which synchronization settings can be configured for a CD.

FIG. 6 is a screen capture illustrating a user interface through which a playlist can be automatically filled with content based on user preferences and/or rules.

### DETAILED DESCRIPTION OF THE PROFFERED EMBODIMENT

Reference will now be made in detail to the preferred embodiments of the present invention, examples of which are illustrated in the accompanying drawings.

An aspect of the present invention allows a user to easily acquire rights to content to be burned to a CD. The rights necessary may vary depending on the rules related to copying such content set forth by the content's author, publisher, or other content provider.

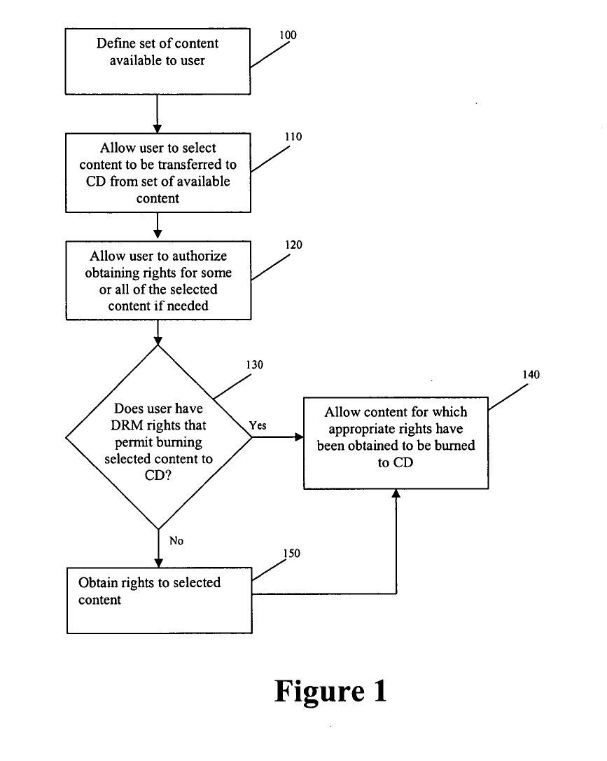

FIG. 1 is a block diagram illustrating a method through which content can be added to a play list associated with a CD. In Block 100 of FIG. 1, a set of content is defined which includes content available to the user. Such content may include, but is not limited to, content ripped by the user, content available to the user by virtue of the user having subscribed to a content provider, and content available for a fee from another source. In a preferred embodiment, such content will have at least one attribute, such as, without limitation, access frequency, size, artist, actor(s), title, genre, producer, director, album, track, scene, or the like associated therewith. Such attributes typically simplify identifying content files and allow users to more easily find and access the associated content.

In Block 110, the user selects content to be transferred to the CD from the set of user-accessible content. In one embodiment, this user-selected content can be stored in a playlist associated with the CD, thereby facilitating maintenance of the content stored on the CD.

In an alternative embodiment, if the user so chooses, new content can be added to a playlist associated with a CD at user-defined intervals, thereby adding variety to the content available to the user via the CD. By way of example, without intending to limit the present invention, if a user has a favorite artist, new content created by that artist can be copied to the CD when the new content becomes available. As another example, the user's content preferences can be determined by analyzing the attributes associated with the contents of a play list. These preferences can then be used to identify content similar to that preferred by the user, and thereby allow the user to access content with which the user is not familiar, and to which the user may not otherwise have had access. Such similarities may be based on user preferences as evidenced by a playlist, including the frequency with which specific content is accessed, the user's ratings of specific content, and the like. The similarities may be based on general content attributes, such as those described above, or based on rhythm, words appearing in the lyrics or script, themes, orchestration, colors, settings, character types, or other such characteristics.

New content can be added to the playlist when requested by the user, or at predefined intervals, such as, without limitation, daily, weekly, or monthly. Similarly, the last date on which content was accessed can be used to determine when new content should be substituted for the content. By way of example, a user may specify that any content that has not been accessed with the past two months is to be removed from a playlist, and new content substituted therefore.

New content can be substituted for another entry or entries in a playlist associated with a portable media player, as necessary, based on one or more criteria. Such criteria can include, but are not limited to, the space available on the CD, the number of content files supported by the CD, and the like. Selection of content to be removed from a playlist can occur based on a variety of user-selectable options. By way of example, without intending to limit the present invention, the user may select the content to be removed. Continuing the example, the content may be automatically removed based on the frequency with which the content has been accessed by the user; the user's rating of the content; the user's preference for a given genre, artist, or the like; or combinations thereof. Such preferences may be determined based on the content comprising the playlist.

In Block 120, the user can authorize the software to obtain rights sufficient to allow some or all of the selected content to be burned to a CD. In one embodiment of this step, the user can identify favorite artists, favorite genres, or enter more complex rules, and thereby pre-authorize the purchasing of any rights necessary to allow burning to the CD of any new content meeting the user's specifications. By way of example, without intending to limit the present invention, a user may like music by the Rolling Stones, but may not care for some of the Rolling Stones' early works. Such a user can enter a rule that pre-authorizes the purchase of any new Rolling Stones songs that may become available, but which does not pre-authorize the purchase of Rolling Stones songs recorded before 1990.

In another embodiment, the user indicate that all rights necessary to permit the selected content to be burned to a CD should be automatically obtained without further user intervention. Still another embodiment requires user intervention for each content file for which rights must be obtained. The set of embodiments described above is intended to be exemplary, and it should be apparent to one skilled in the art that the embodiments can be combined, alternative embodiments may be substituted therefore, or embodiments added thereto, without departing from the spirit or the scope of the invention.

In Block 130, the DRM attributes associated with the content to be transferred to the CD are examined to determine whether the user has rights that permit burning the selected content to a CD. In Block 140, where the content's DRM attributes permit the content to be copied to a CD, burning of the selected tracks is allowed.

Where the user does not have appropriate rights, the appropriate rights are obtained to the content consistent with the user's preferences as set forth in Block 120. If no such preferences are specified, the user is preferably asked to authorize obtaining rights for each content file for which such rights are necessary.

While FIG. 1 presents blocks 100 through 130 as occurring in a particular order, it should be apparent to one skilled in the art that alternative orders may be substituted therefore without departing from the spirit or the scope of the invention.

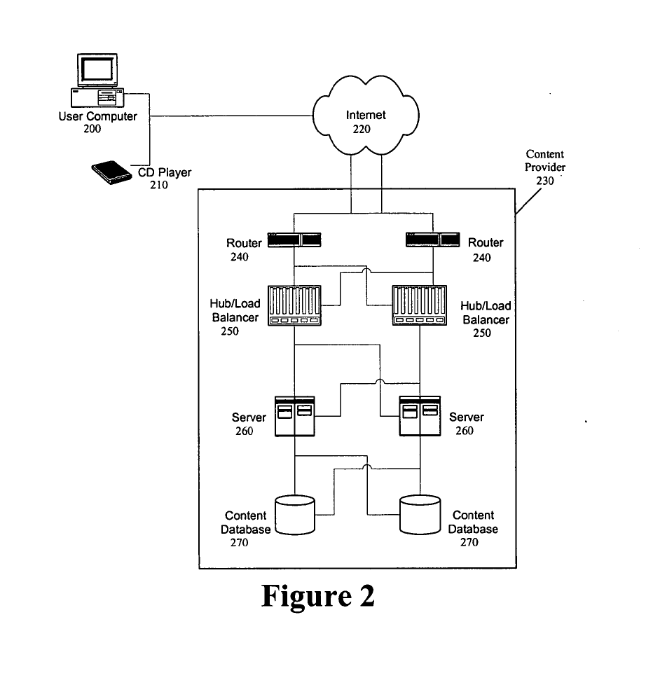

FIG. 2 illustrates an exemplary architecture through which the present invention can be implemented. In the embodiment illustrated in FIG. 2, it is assumed, as is standard at the present time, that CD Player/Burner 210 has limited communication and/or storage capabilities, and thus content to be burned by CD Player/Burner 210 must be obtained via a local resource such as user computer 200. However, it should be apparent to one skilled in the art that alternative content acquisition means, such as, without limitation, allowing CD Player/Burner 210 to directly access Internet 230, or allowing CD Player/Burner 210 to communicate directly with server 260 or content database 270 via a dedicated communications means, can be substituted therefore without departing from the spirit or the scope of the invention.

In the embodiment of FIG. 2, content is provided by content provider 230 to one or more user computers 200 via Internet 220. In the illustrated embodiment, content provider 230 employs a redundant architecture to provide improved availability, reliability, and scalability. While a redundant architecture is preferred, it should be apparent to one skilled in the art that a single server may be substituted therefore without departing from the spirit or the scope of the invention. Similarly, although a redundant architecture with only two of each hardware device is illustrated, it should be apparent to one skilled in the art that additional hardware devices can be added, or hardware devices removed, without departing from the spirit or the scope of the invention.

In the illustrated embodiment, routers 240 facilitate proper traffic flow between Internet 220 and other hardware employed by content provider 230. Router 240 may also provide firewall protection and other such services.

Routers 240 are communicatively coupled to hub/load balancers 250. Hub/load balancers 250 can preferably monitor the capabilities, workload assignments, and response times for each of servers 260. This allows hub/load balancers 250 to select the appropriate server or servers for any new incoming service requests.

In the illustrated embodiment, servers 260 preferably provide an interface to content databases 270. Servers 260 preferably authenticate users, control user access to content stored in content databases 270, monitor DRM rights associated with content stored in content databases 270, provide user computer 200 with a list of DRM compatible portable entertainment devices, and perform other such functions. Servers 260 preferably use hypertext markup language (“HTML”), eXtensible Markup Language (“XML”) or other structured language to provide such an interface. In one embodiment, user computer 200 employs a browser or other software application capable of receiving HTML or XML information from servers 260 and converting this information into a user-readable form.

Users accessing user computer 200 can preferably select content to be downloaded and stored locally on user computer 200, to access content streamed to user computer 200 via content provider 230, and the like. As described above with Respect to FIG. 1, where the DRM rights of a given content file permit burning the content file to a CD, the user can transfer content from user computer 200 to CD Player/Burner 210 via a wired or wireless connection. This can be done, for example, by associating a playlist stored on user computer 200 with a CD in CD Player/Burner 210.

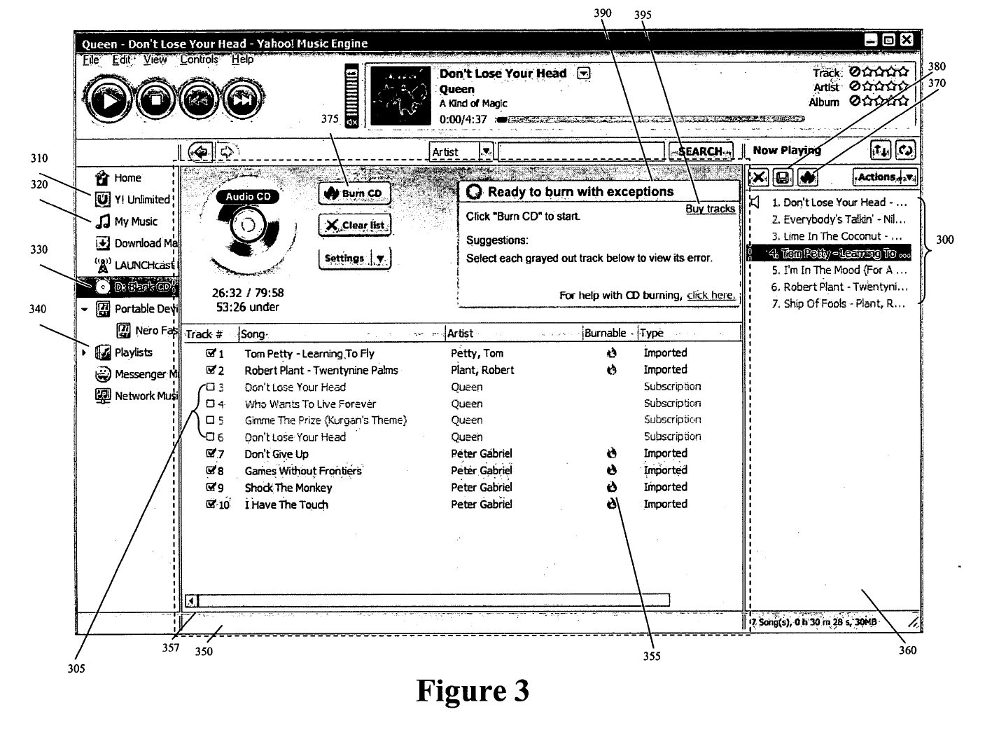

Another aspect of the present invention is the provision of a user Interface through which playlists can be created, associated with a CD, and maintained. Exemplary embodiments of such a user interface are illustrated in FIGS. 3 through 6. In the embodiment illustrated in FIG. 3, content is made available to the user from a plurality of content sources, including subscription service 310 and local content 320. When the user selects a content source, the user is presented with a list of available content. Such content can be organized based on one or more content attributes. In the illustrated embodiment, the content is organized by genre, with individual content entries listed in content pane 350. The user can select one or more content entries from a content pane and drag them to playlist area 360, where they are listed as content entries 300. When the user is satisfied with the content in playlist area 360, the user can store the playlist by clicking Save button 380. The playlist will then appear under playlists 340. When the user is ready to burn the content listed in the playlist to a CD, such as the Blank CD listed in CDs list 330, the user can click burn to CD button 370 or otherwise interact with a user interface element to initiate the burning process. An exemplary user interface for such a process is illustrated by region 350 of FIG. 3.

In a preferred embodiment, the DRM attributes of the selected content are examined to determine whether the user's rights are compatible with burning the content to a CD. If the user's rights are not compatible with burning the content to a CD, the user interface preferably indicates the incompatibility to the user. In the embodiment illustrated in FIG. 3, the user does not have rights compatible with burning content entries 305 to a CD, and the content entries are grayed out. In alternative embodiments, alternative means for indicating DRM incompatibilities may be used, including, without limitation, striking through the content entries, using a bold or italic font, using an alternative font, using an alternative font color, placing a DRM-associated icon next to or near the content entry, such as burnable icon 355, and the like.

Where rights permitting the selected content to be burned to a CD have not yet been obtained for one or more content files, a dialog box or other user interface element similar to that of user interface element 390 can be presented to the user. Such a user interface element preferably identifies the content for which rights to burn the content to a CD are still needed and provides instructions to the user as to how to remedy the incompatibility.

In one embodiment, the user interface element can allow the user to specify whether any necessary DRM rights are to be automatically obtained or whether such rights should be obtained through various degrees of user interaction. In another embodiment, the user interface element can allow the user to click on a single button, link, or the like, such as buy tracks link 395, to purchase the necessary rights to permit the entire set of selected content to be burned to a CD.

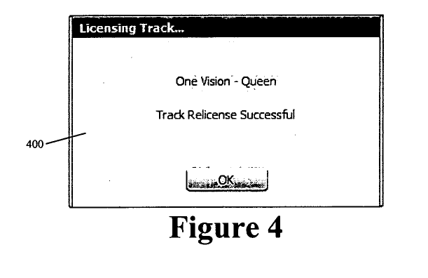

In a preferred embodiment, the user is advised as to the status of any license acquisition or reacquisition via a dialog box or other user interface element such as the dialog box 400 illustrated in FIG. 4. By way of example, without intending to limit the present invention, status information may also or alternatively be presented in status bar 357 of FIG. 3. The status information may also include the cost of any necessary licenses, and can allow the user to authorize payment of such costs. Payment can be made at that time via a credit card, debit card, or debit account associated with the user, or by adding the cost to the user's monthly fee. It should be apparent to one skilled in the art that alternative payment means may be substituted for those described herein without departing from the spirit or the scope of the invention.

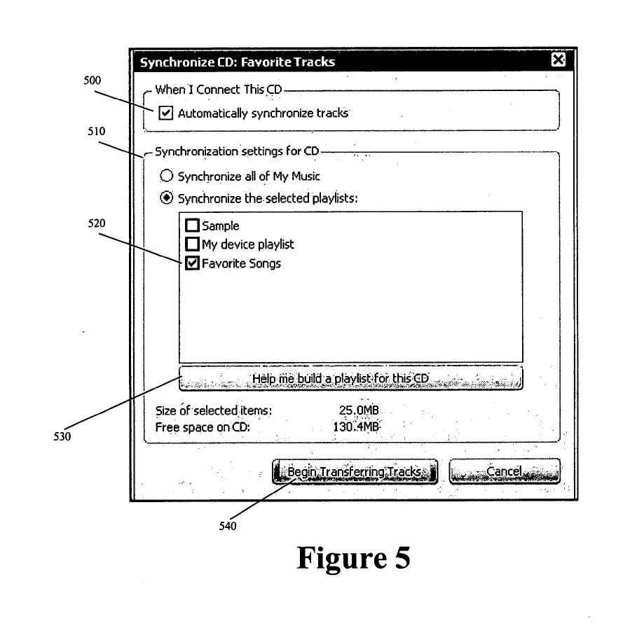

FIG. 5 is a screen capture of an exemplary user interface through which the user can indicate one or more synchronization preferences for a given CD. Such synchronization may occur, for example, when a single-write CD still has storage capacity, or where the CD is rewritable. In this embodiment, the user can select, by checking checkbox 500, whether content should be automatically synchronized each time the CD is communicatively coupled to a content source, such as a local computer or content provider. If the CD is to be synchronized, the user can specify the synchronization settings in synchronization settings 510. In the illustrated embodiment, the user can elect to have all available local content synchronized, or to have content associated with one or more playlists, illustrated in Playlists 520, synchronized with the CD. Where the user wishes to create a new playlist to be associated with a CD, the user can click on build playlist button 530 or other activate another such user interface element.

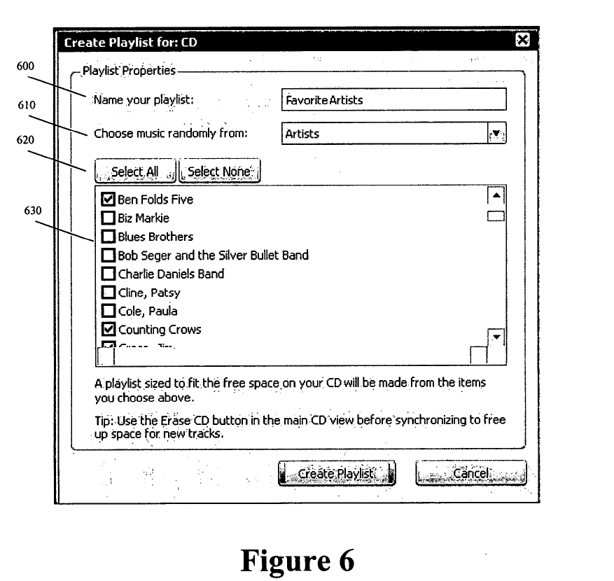

Clicking on build playlist button 530 preferably causes a window similar to that illustrated in FIG. 6 to appear. The playlist creation window illustrated in FIG. 6 allows the user to name the playlist in text box 600, and to create rules governing how content is to be added to the playlist. In the illustrated embodiment, the user selects a content attribute type from content attribute type list 610, which causes a list of available content attributes to be listed in content attribute list 630. The user can then select one or more content attributes from content attribute list 630, or select all available content attributes using select all button 620. The user then clicks Create Playlist 640 or otherwise activates another such user interface element to initiate the generation of a playlist according to the rules specified by the user. Once the playlist has been generated, the content associated with the playlist can be burned to a CD using the methods described above.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

1-27. (canceled)

28. A method, comprising:
receiving at a server computing device from a user computing device a selection of a first unit of digital content of a first digital content set;
determining a second digital content set based at least in part on one or more attributes of the selected first unit of digital content utilizing, at least in part, a processor of the server computing device;
obtaining a user preference regarding obtaining digital rights for one or more units of digital content from the second digital content set, the digital rights including rights for the user to consume the one or more units of digital content from the second digital content set;
obtaining the digital rights for the one or more units of digital content from the second digital content set at least in part in accordance with the user preference; and
transmitting an indication of obtained digital rights from the server computing device to the user computing device.

29. The method of claim 28, wherein said obtaining the digital rights for the one or more units of digital content comprises automatically obtaining the rights at least in part in response to receiving the user preference.

30. The method of claim 28, further comprising transmitting the one or more units of digital content from the second digital content set from the server computing device to the user computing device at least in part in response to obtaining the digital rights for the one or more units of digital content from the second digital content set.

31. The method of claim 28, wherein the rights for the user to consume the one or more units of digital content from the second digital content set includes rights to burn the one or more units of digital content from the second digital content set to a CD.

32. The method of claim 28, further comprising the server computing device to add the one or more units of digital content from the second digital content set to a playlist.

33. The method of claim 32, wherein the rights for the user to consume the one or more units of digital content from the second digital content set includes rights to burn the one or more units of digital content from the playlist to a CD.

34. The method of claim 28, further comprising determining whether digital rights for one or more units of digital content from the first digital content set have expired at least in part in response to receiving the selection from the user computing device.

35. The method of claim 34, further comprising automatically obtaining additional digital rights for the one or more units of digital content objects from the first digital content set whose digital rights have expired.

36. An article, comprising: a non-transitory computer-readable medium having stored thereon instructions executable by a processor a computing platform to:
obtain at a server computing device from a user computing device a selection of a first unit of digital content of a first digital content set;
determine a second digital content set based at least in part on one or more attributes of the selected first unit of digital content;
obtain a user preference regarding obtaining digital rights for one or more units of digital content from the second digital content set, the digital rights including rights for the user to consume the one or more units of digital content from the second digital content set;
obtain the digital rights for the one or more units of digital content from the second digital content set at least in part in accordance with the user preference; and
transmit an indication of obtained digital rights from the server computing device to the user computing device.

37. The article of claim 36, wherein the computer readable medium has stored thereon further instructions executable by the computing platform to obtain the digital rights for the one or more units of digital content at least in part by automatically obtaining the rights at least in part in response to receiving the user preference.

38. The article of claim 36, wherein the computer readable medium has stored thereon further instructions executable by the computing platform to transmit the one or more units of digital content from the second digital content set from the server computing device to the user computing device at least in part in response to obtaining the digital rights for the one or more units of digital content from the second digital content set.

39. The article of claim 36, wherein the rights for the user to consume the one or more units of digital content from the second digital content set includes rights to burn the one or more units of digital content from the second digital content set to a CD.

40. The article of claim 36, further wherein the computer readable medium has stored thereon further instructions executable by the computing platform to add the one or more units of digital content from the second digital content set to a playlist.

41. The article of claim 40, wherein the rights for the user to consume the one or more units of digital content from the second digital content set includes rights to burn a digital content object from the playlist to a CD.

42. The article of claim 36, wherein the computer readable medium has stored thereon further instructions executable by the computing platform to determine whether digital rights for one or more units of digital content from the first digital content set have expired at least in part in response to receiving the selection from the user computing device.

43. The article of claim 42, wherein the computer readable medium has stored thereon further instructions executable by the computing platform to automatically obtain additional digital rights for the one or more units of digital content from the first digital content set whose digital rights have expired.

44. An apparatus, comprising:
a processor to obtain from a user computing device a selection of a first digital content object of a first digital content object set, the processor further to determine a second digital content object set comprising digital content objects based at least in part on one or more attributes of the selected first digital content object, to obtain a user preference regarding obtaining digital rights for one or more digital content objects from the second digital content object set, the digital rights including rights for the user to consume the one or more digital content objects from the second digital content object set, and to obtain the digital rights for the one or more digital content object from the second digital content object set at least in part in accordance with the user preference, the processor further to initiate transmission of an indication of obtained digital rights from the server computing device to the user computing device.

45. The apparatus of claim 44, the processor to obtaining the digital rights for the one or more digital content objects at least in part by automatically obtaining the rights at least in part in response to receiving the user preference.

46. The apparatus of claim 44, the processor further to initiate transmission of the one or more digital content objects from the second digital content object set from the server computing device to the user computing device at least in part in response to obtaining the digital rights for the one or more digital content objects from the second digital content object set.

47. The apparatus of claim 44, wherein the rights for the user to consume the one or more digital content objects from the second digital content object set includes rights to burn the one or more digital content objects from the second digital content object set to a CD.

48. The apparatus of claim 44, the processor further to add the one or more digital content objects from the second digital content object set to a playlist.
